(19) United States
(12) Patent Application Publication
(10) Pub. No.: US 2025/0049055 A1
(43) Pub. Date: Feb. 13, 2025

(54) MICROWAVE OVEN SMOKING CONTAINER

(71) Applicants: Jae El KIM, Ansan-si, Gyeonggi-do (KR); NEULU CO.,LTD., Hwaseong-si, Gyeonggi-do (KR)

(72) Inventor: Jae El KIM, Ansan-si, Gyeonggi-do (KR)

(73) Assignees: Jae El KIM, Ansan-si, Gyeonggi-do (KR); NEULU CO.,LTD., Hwaseong-si, Gyeonggi-do (KR)

(21) Appl. No.: 18/721,706

(22) PCT Filed: Dec. 14, 2022
(86) PCT No.: PCT/KR2022/020383

§ 371 Date: Jun. 19, 2024

(30) Foreign Application Priority Data
Dec. 28, 2021 (KR) 10-2021-0189801

(51) Int. Cl. A23B 4/056; A47J 36/02; A47J 36/06; H05B 6/64

(52) U.S. Cl. CPC A23B 4/056; A47J 36/027; A47J 36/06; H05B 6/6494

(57) ABSTRACT

A microwave oven smoking container includes: a container body in which food material is accommodated; a container lid for covering the top of the container body; a smoke-generating part formed in the container lid; a first heating element which is disposed inside the smoke-generating part, and which generates heat by means of the electromagnetic waves of the microwave oven; and sawdust arranged inside the smoke-generating part, and arranged to be in close contact with the first heating element so as to generate smoke during heat generation by the first heating element, wherein the smoke-generating part or the container lid has a through-hole allowing communication with the inside of the container body, smoke is generated from the sawdust while the first heating element generates heat by means of the electromagnetic waves of the microwave oven, and the generated smoke flows into the container body through the through-hole.

### TECHNICAL FIELD

The present invention relates to a microwave oven smoking container, and more particularly, to a microwave oven smoking container in which a smoked food is cooked in a cooking container by operating a microwave oven.

### BACKGROUND ART

In general, among microwave ovens, combination microwave ovens capable of cooking a variety of food using electric heat of electric heaters and performing unique cooking functions using electromagnetic waves at the same time are common.

In addition, there have also been conventional combination microwave ovens in which a drawer with an embedded electric heater is installed on one surface of the microwave oven, and a smoking material stored in the drawer is heated using the heater to generate smoke to cook a smoked food infused with a unique smell and taste.

However, microwave ovens having such a smoking function had problems that they were not easy to manage and were expensive and smoke remained in the microwave oven after smoking.

Meanwhile, a microwave oven smoking container is disclosed in Korean Laid-open Utility Patent No. 93-3941.

The smoking container is convenient in that the smoking container may be put in a general microwave oven to cook smoked food.

However, since a smoking material is disposed under the food, it had a problem that moisture, oil, and the like generated from the food fell and attached to the smoking material and thus ash was scattered or smell which was different from the original smoke smell was generated.

In addition, since a smoking material was placed on a lower support, the smoking material had to be supplemented after the entire container except for the lower support was lifted in order to supplement the smoking material, which was inconvenient.

In addition, there were problems that, since oil and the like generated from food fell and blocked a hole through which smoke passed, smoke did not move smoothly and it was not easy to clean the oil attached to the hole.

### Technical Problem

The present invention is directed to solving the above-described problems by providing a microwave oven smoking container which prevents ash from being scattered or smell which is different from original smoke smell from being generated due to moisture, oil, and the like generated from food and in which a smoking material is easily replaced or added, a hole through which smoke passes is not blocked by the oil and the like generated from the food, and cleaning is easy.

### Technical Solution

In order to achieve the above objectives, one aspect of the present invention provides a microwave oven smoking container including a container body in which food is accommodated, a container lid which covers an upper portion of the container body, a smoke-generating part formed in the container lid, a first heating element disposed in the smoke-generating part and configured to generate heat using electromagnetic waves of a microwave oven, and sawdust which is disposed in the smoke-generating part in close contact with the first heating element and generates smoke when the first heating element generates heat, wherein a through-hole communicating with an inside of the container body is formed in the smoke-generating part or the container lid, the smoke is generated from the sawdust while the first heating element generates heat using the electromagnetic waves of the smoke microwave oven, and the generated smoke is introduced into the container body through the through-hole.

The smoke-generating part may include a mounting groove formed such that an upper portion of the container lid is concavely recessed downward and a smoke cover part which covers an upper portion of the mounting groove, the first heating element and the sawdust may be disposed in the mounting groove, and the through-hole may be formed in the mounting groove.

The first heating element may be fixedly coupled to the mounting groove, and the sawdust may be put in the mounting groove and stacked on the first heating element.

The through-hole is formed in the mounting groove in a lateral direction.

The through-hole formed in the mounting groove in the lateral direction may be located at a higher level than the first heating element and the sawdust.

The smoke cover part may be detachably coupled to the upper portion of the mounting groove.

Alternatively, the smoke cover part may be fixedly coupled to the upper portion of the mounting groove.

In addition, the smoke-generating part may be mounted in the container lid, and the through-hole may be formed in the smoke-generating part.

Alternatively, the smoke-generating part may be mounted on an outer portion of the container lid, and the through-hole may be formed in the container lid.

The microwave oven smoking container may further include a second heating element embedded in a lower portion of the container body, and the second heating element may generate heat using the electromagnetic waves to heat the container body.

The container body includes an external container body and an internal container body detachably disposed in the external container body, and the second heating element may be embedded in the external container body.

### Advantageous Effects

A microwave oven smoking container of the present invention described above has the following effects.

In the present invention, since a smoking material, that is, a first heating element and sawdust, is disposed in a container lid disposed above food instead of under the food, problems of ash scattering or a smell which is different from the original smoke smell being generated when moisture, oil, and the like generated from the food fall and are attached to the smoking material can be prevented.

In addition, since a smoke cover part detachably mounted on the container lid can be opened, and the smoking material can fill the container lid or can be replaced, the smoking material is easily supplemented.

In addition, since a through-hole which is a passage through which smoke generated from the smoking material moves is located at a higher level than the food, a problem that the smoke does not move smoothly due to blockage of the through-hole by the oil generated from the food does not occur, and since the oil is not attached to the through-hole, there is an effect of easily cleaning and washing.

### DESCRIPTION OF DRAWINGS

FIG. 1 is a perspective view illustrating a cooking container according to a first embodiment of the present invention.

FIG. 2 is a cross-sectional structural view along line A-A of FIG. 1.

FIG. 3 is a view illustrating a use state of the cooking container according to the first embodiment of the present invention.

FIG. 4 shows cross-sectional structural views illustrating cooking containers according to modified embodiments of the first embodiment of the present invention.

FIG. 5 is a cross-sectional structural view illustrating a cooking container according to a second embodiment of the present invention.

FIG. 6 shows cross-sectional structural views illustrating cooking containers according to a third embodiment of the present invention.

### MODES OF THE INVENTION

### First Embodiment

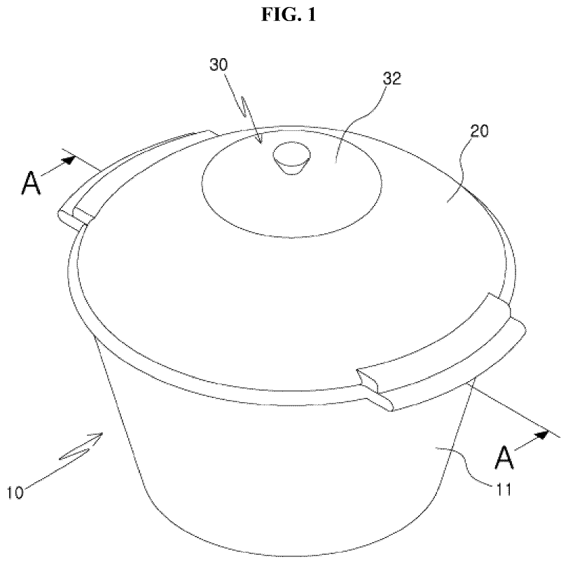

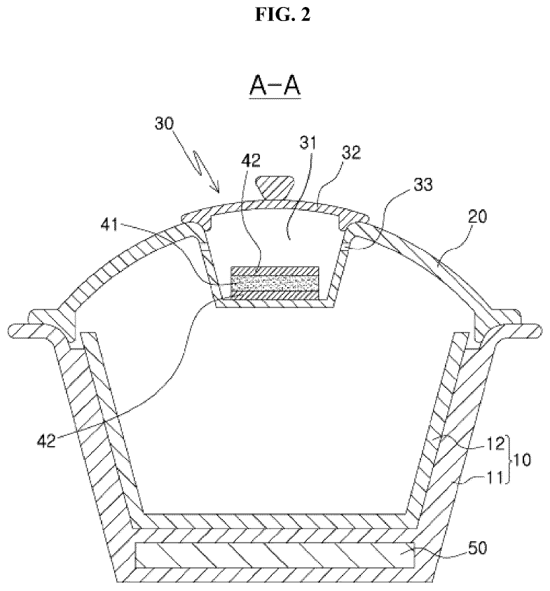

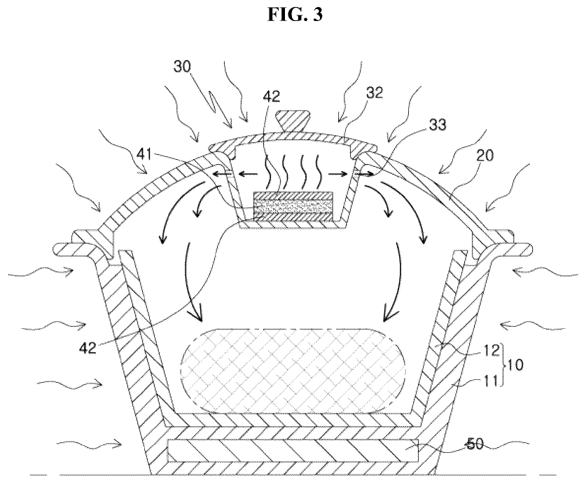

FIG. 1 is a perspective view illustrating a cooking container according to a first embodiment of the present invention, FIG. 2 is a cross-sectional structural view along line A-A of FIG. 1, and FIG. 3 is a view illustrating a use state of the cooking container according to the first embodiment of the present invention.

As illustrated in FIGS. 1 to 3, a microwave oven smoking container of the present invention includes a container body 10, a container lid 20, a smoke-generating part 30, a first heating element 41, and sawdust 42.

A space for accommodating food is formed in the container body 10.

The container lid 20 serves to cover an upper portion of the container body 10.

The smoke-generating part 30 is formed in the container lid 20.

In the present embodiment, the smoke-generating part 30 is provided with a mounting groove 31 and a smoke cover part 32.

The mounting groove 31 is formed such that an upper portion of the container lid 20 is concavely recessed downward.

The smoke cover part 32 covers an upper portion of the mounting groove 31.

In this case, the smoke cover part 32 is formed to have a shape and structure which allows the upper portion of the mounting groove 31 to be repeatedly opened and closed.

The smoke cover part 32 is formed of silicone, heat-resistant plastic, mica, a ceramic, glass, etc., through which an electromagnetic wave may pass.

In the present embodiment, the smoke cover part 32 is detachably coupled to the upper portion of the mounting groove 31.

In addition, smoking materials, that is, the first heating element 41 and the sawdust 42, are disposed in the mounting groove 31.

A through-hole 33 communicating with the inside of the container body 10 is formed in the smoke-generating part 30 or the container lid 20.

The through-hole 33 forms a passage such that smoke generated from the sawdust 42 moves into the container body 10 as will be described below.

In the present embodiment, the through-hole 33 is formed in the mounting groove 31.

The through-hole 33 may be formed in the mounting groove 31 in various directions.

In particular, the through-hole 33 formed in the mounting groove 31 may be more preferably located at a higher level than the first heating element 41 and the sawdust 42.

Accordingly, the sawdust 42 or ash remaining after the sawdust 42 is burned may be prevented from falling into the container body 10 through the through-hole 33.

The first heating element 41 is disposed in the smoke-generating part 30, specifically, in the mounting groove 31 and generates heat using electromagnetic waves of a microwave oven.

The first heating element 41 is a known susceptor which generates heat using the electromagnetic waves of the microwave oven and formed of iron oxide, carbon, silicon carbide, etc.

The sawdust 42 is disposed in the smoke-generating part 30, specifically, in the mounting groove 31, and disposed in close contact with the first heating element 41 to serve to generate smoke when the first heating element 41 generates heat.

The sawdust 42 is generally formed of a material used for smoking such as oak.

In the drawings of the present embodiment, the sawdust 42 is attached to each of an upper surface and a lower surface of the first heating element 41.

Unlike the present embodiment, a first heating element 41 and sawdust 42 may be provided as powders and formed into a mixed lump, or sawdust 42 may be disposed to be stacked on a first heating element 41.

That is, any structure is possible as long as smoke can be generated from sawdust 42 by heat of a first heating element 41 when the first heating element 41 generates the heat.

Meanwhile, a second heating element 50 may be embedded in a lower portion of the container body 10 of the present invention.

The second heating element 50 heats the container body 10 heated by the electromagnetic waves of the microwave oven.

Due to the second heating element 50, when food is put in the container body 10 and the microwave oven is operated, the second heating element 50 generates heat to quickly and effectively heat the food put in the container body 10.

However, in some cases, the second heating element 50 may be omitted.

In addition, the container body 10 may be provided as only one container body 10, or provided as an external container body 11 and an internal container body 12.

The second heating element 50 is embedded in the external container body 11.

The internal container body 12 is detachably disposed in the external container body 11.

Since the container body 10 includes the external container body 11 and the internal container body 12 as described above, food may be put in the external container body 11, or food may be put in the internal container body 12 as necessary.

Hereinafter, an operating process of the present invention provided with the above-described components will be described.

Food is put in the container body 10, and the container body 10 is covered by the container lid 20.

In addition, illustrated in FIG. 2, the first heating element 41 and the sawdust 42 are put in the mounting groove 31 and covered by the smoke cover part 32.

Then, the cooking container is put in the microwave oven, and the microwave oven is operated.

The second heating element 50 generates heat using electromagnetic waves generated as the microwave oven is operated to heat the food put in the container body 10.

In addition, as illustrated in FIG. 3, the first heating element 41 generates heat using the electromagnetic waves to heat the sawdust 42 disposed therearound and generate smoke.

The smoke generated from the sawdust 42 moves to the container body 10 through the through-hole 33 and is absorbed by the food so that the food can be smoked.

In addition, when the microwave oven smoking container needs to be reused, the smoke cover part 32 is opened, the first heating element 41 and the sawdust 42 are replaced, and then the microwave oven smoking container can be repeatedly used.

As described above, through the present invention, food can be smoked using electromagnetic waves of a microwave oven, and thus smoked food can be cooked.

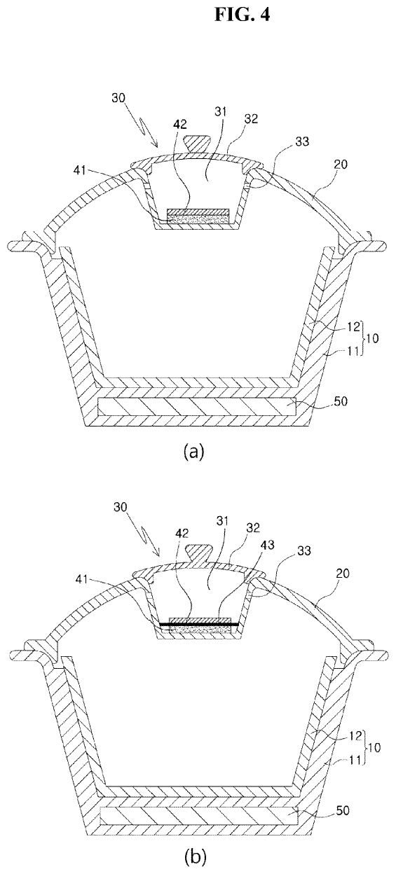

As illustrated in FIG. 4A, in some cases, a first heating element 41 may be fixedly coupled to a mounting groove 31, and only sawdust 42 may be replaced and repeatedly added onto the first heating element 41.

In addition, as illustrated in FIG. 4B, a flame-retardant material 43, for example, a mica plate through which electromagnetic waves may pass, is stacked on a first heating element 41, and sawdust 42 may be replaced and repeatedly added onto the flame-retardant material 43.

In this way, since only the sawdust 42 is replaced, it is convenient to use, and waste of the material can be reduced.

In this case, as illustrated in FIG. 4B, the flame-retardant material 43 may cover an upper portion of the first heating element 41 to prevent the sawdust 42 from being introduced into a location at which the first heating element 41 is disposed.

In the present invention, the smoking materials, that is, the first heating element 41 and the sawdust 42, are disposed in the container lid 20 disposed above food instead of under the food, and therefore a problem of ash scattering or a smell which is different from the original smoke smell generated when moisture, oil, and the like generated from the food fall and are attached to the smoking material can be prevented.

In addition, since the smoke cover part 32 detachably mounted on the container lid 20 may be opened, and the smoking material may fill the container lid 20 and may be replaced, the smoking material can be easily supplemented.

In addition, since the through-hole 33 which is a passage through which smoke generated from the smoking material moves is located at a higher level than food, a problem that the smoke does not move smoothly due to blockage of the through-hole 33 by oil and the like generated from the food does not occur, and since the oil is not attached to the through-hole 33, there is an effect of easily cleaning and washing.

### Second Embodiment

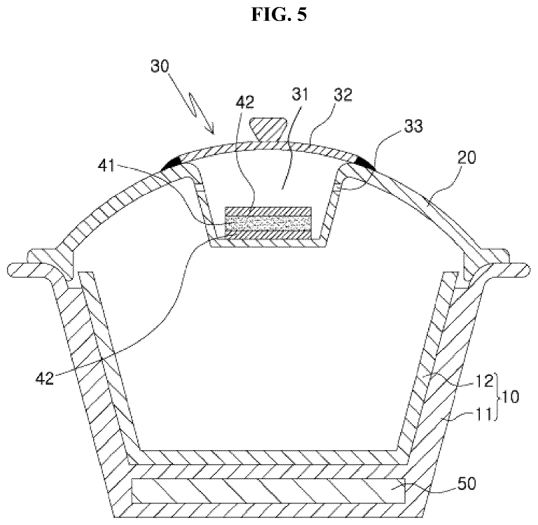

FIG. 5 is a cross-sectional structural view illustrating a cooking container according to a second embodiment of the present invention.

In the second embodiment, a smoke cover part 32 is different from the smoke cover part 32 of the first embodiment.

As illustrated in FIG. 5, in the present embodiment, the smoke cover part 32 is formed of a plate formed of a flame-retardant material, and the smoke cover part 32 is fixedly mounted on an upper portion of the mounting groove 31.

That is, unlike the first embodiment, the smoke cover part 32 is fixed to the mounting groove 31 without being attached to or detached from the mounting groove 31.

In this case, the first heating element 41 and the sawdust 42 are embedded in the mounting groove 31.

Since the first heating element 41 and the sawdust 42 may not be replaced and used, the structure of the present embodiment is suitable when a container lid 20 or an entire cooking container is used for a disposable purpose.

Since the other components of the second embodiment are the same as those of the first embodiment, detailed description thereof will be omitted.

### Third Embodiment

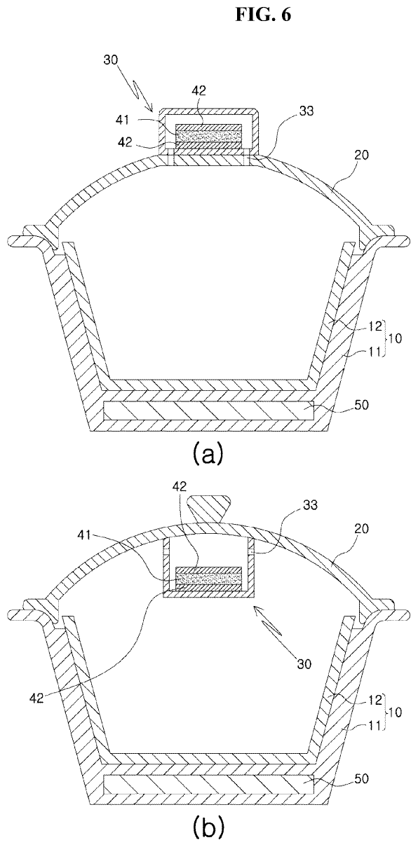

FIG. 6 is a cross-sectional structural view illustrating a cooking container according to a third embodiment of the present invention.

In the third embodiment, since a location of a smoke-generating part 30 is different from a location of the smoke-generating part 30 of the first embodiment, the difference will be mainly described.

As illustrated in FIG. 6A, the smoke-generating part 30 may be mounted on an outer portion of the container lid 20.

In this case, the through-hole 33 is formed in the container lid 20.

In addition, as illustrated in FIG. 6B, the smoke-generating part 30 may be mounted inside the container lid 20.

In this case, the through-hole 33 is formed in the smoke-generating part 30.

Since the other components of the third embodiment are the same as those of the first embodiment, detailed description thereof will be omitted.

The microwave oven smoking container of the present invention is not limited to the above-described embodiments and may be variously modified and implemented within the scope of the technical spirit of the present invention.

### INDUSTRIAL APPLICABILITY

Since the present invention can be applied to a microwave oven smoking container, the present invention is industrially applicable.

1. A microwave oven smoking container comprising:
a container body in which food is accommodated;
a container lid which covers an upper portion of the container body;
a smoke-generating part including a mounting groove formed such that an upper portion of the container lid concavely recessed downward and a smoke cover part which covers an upper portion of the mounting groove;
a first heating element disposed in the mounting groove and configured to generate heat using electromagnetic waves of a microwave oven; and
sawdust which is disposed in the mounting groove, is disposed in close contact with the first heating element, and generates smoke when the first heating element generates heat,
wherein a through-hole communicating with an inside of the container body is formed in the mounting groove,
the through-hole formed in the mounting groove is located at a higher level than the first heating element and the sawdust to prevent the sawdust or ash remaining after the sawdust is burned from falling into the container body through the through-hole,
the smoke is generated from the sawdust while the first heating element generates heat using the electromagnetic waves of the microwave oven, and
the generated smoke is introduced into the container body through the through-hole located at a higher level than the first heating element and the sawdust.

2. The microwave oven smoking container of claim 1, wherein:
the first heating element configured to generate heat using the electromagnetic waves is fixedly coupled to the mounting groove; and
the sawdust is put in the mounting groove and stacked on the first heating element.

3. The microwave oven smoking container of claim 2, wherein:
a flame-retardant material through which the electromagnetic waves pass is stacked on the first heating element;
the sawdust is added onto and stacked on the flame-retardant material; and
the flame-retardant material covers the first heating element disposed under the flame-retardant material.

4. The microwave oven smoking container of claim 1, wherein the smoke cover part is detachably coupled to the upper portion of the mounting groove.

5. The microwave oven smoking container of claim 1, wherein the smoke cover part is fixedly mounted on the mounting groove.

6. The microwave oven smoking container of claim 1, further comprising a second heating element embedded in a lower portion of the container body,
wherein the second heating element generates heat using the electromagnetic waves to heat the container body.

7. The microwave oven smoking container of claim 6, wherein:
the container body includes an external container body and an internal container body detachably disposed in the external container body; and
the second heating element is embedded in the external container body.
